(19) United States
(12) Patent Application Publication
(10) Pub. No.: US 2013/0252554 A1
(43) Pub. Date: Sep. 26, 2013

(54) WIRELESS COMMUNICATION DEVICE AND WIRELESS COMMUNICATION SYSTEM

(71) Applicant: KABUSHIKI KAISHA TOSHIBA, Tokyo (JP)

(72) Inventor: Hideaki NAKAKITA, Kanagawa (JP)

(73) Assignee: KABUSHIKI KAISHA TOSHIBA, Tokyo (JP)

(21) Appl. No.: 13/784,663

(22) Filed: Mar. 4, 2013

(30) Foreign Application Priority Data
Mar. 16, 2012 (JP) P2012061173

(51) Int. Cl. H04W 72/08

(52) U.S. Cl. CPC H04W 72/082
USPC 455/41.2

(57) ABSTRACT

A wireless communication device includes a first wireless communication device that conforms to the Bluetooth standard, and a second wireless communication device that conforms to a second wireless communication standard different from the Bluetooth standard. The first and second wireless communication device are connected to each other by means of a signal line by which wireless communication arbitration control between the two devices is carried out. When Bluetooth communication between the first wireless communication device and a third wireless communication device is granted, a mask setting component generates a mask interval, during which the second wireless communication device is not permitted to perform wireless communication.

### CROSS-REFERENCE TO RELATED APPLICATION

This application is based upon and claims the benefit of priority from Japanese Patent Application No. 2012-061173, filed Mar. 16, 2012; the entire contents of which are incorporated herein by reference.

### FIELD

Embodiments described herein relate to a wireless communication device.

### BACKGROUND

A wireless communication standard can use an unlicensed frequency band. For example, Bluetooth® is a wireless communication standard that uses the 2.4 GHz band, which is an unlicensed frequency band. Due to this unlicensed usage, there may be interference with the communications of other wireless communication standards that use the unlicensed frequency band (e.g., 2.4 GHz band).

For example, there are integrated circuit devices, etc., that are implemented so as to have a Bluetooth® device and a WiFi device coexisting within the same housing, and these two devices are coupled by dedicated signal lines. In the above configuration, a communication arbitration control is carried out in time units of Bluetooth® slots (e.g., 625 μs) to ensure that Bluetooth® communication and WiFi communication do not interfere. In this method, since any one of the communications with a higher priority would be permitted, it is possible for both devices within the same housing to communicate mutually at substantially the same time and to reduce the probability of interference. Unfortunately, an entire data packet remains unprotected in this method.

### DESCRIPTION OF THE DRAWINGS

FIG. 1 is a block diagram showing a wireless communication integrated circuit according to an embodiment.

FIG. 2 is a block diagram showing the mask setting component of FIG. 1.

FIG. 3 is a timing chart diagram showing a multi-slot packet communication of the wireless communication integrated circuit according to an embodiment.

FIG. 4 is a timing chart diagram showing the low energy (LE) packet burst communication of the wireless communication integrated circuit according to an embodiment.

FIG. 5 is a block diagram showing a wireless communication integrated circuit according to a reference example.

FIG. 6 is a timing chart diagram showing a multi-slot packet communication of a wireless communication integrated circuit according to a reference example.

### DETAILED DESCRIPTION

A wireless communication device and a wireless communication system are provided to protect an entire data packet.

In general, communication arbitration for Bluetooth® packets that span multiple Bluetooth® slots (henceforth referred to as Bluetooth® multi-slot packet) may be disturbed. When this happens, there may be no choice but to suspend it.

According to embodiments of the disclosure, a first wireless communication device that conforms to the Bluetooth® standard, and carries out communication arbitration control with a second wireless communication device, that conforms to a second wireless communication standard other than the Bluetooth® standard. When Bluetooth® communication is permitted, the first wireless communication device carries out wireless communication with a third wireless communication device that conforms to the Bluetooth® standard, and controls arbitration of the wireless communication usage between the first and second wireless communication devices by creating a mask interval during which new wireless communication requests from the second wireless communication device is not accepted.

Therefore, in the following embodiments, a Bluetooth® device is proposed that, by providing a mask interval and not accepting communication arbitration control from other devices during the mask interval, does not allow the occurrence of suspend while a Bluetooth® packet, e.g., a Bluetooth® multi-slot packet, is being wirelessly communicated.

Below, various embodiments of the disclosure will be described with reference to the drawings. In this description, although a Bluetooth® device will be cited as an example of a wireless communication device, it need not be limited to this. In addition, in this description, common reference symbols will be used to refer to common parts across all the drawings.

### First Embodiment

A first embodiment provides an example of Bluetooth® multi-slot packet communication. In the first embodiment, once communication has been allowed, a mask interval is generated during the communication interval of the Bluetooth® multi-slot packet, and the Bluetooth® device does not allow a suspend during this communication interval by not accepting communication arbitration control from devices of other wireless standards.

### 1. Configuration of First Embodiment

### 1-1. Overall Configuration of Wireless Communication System

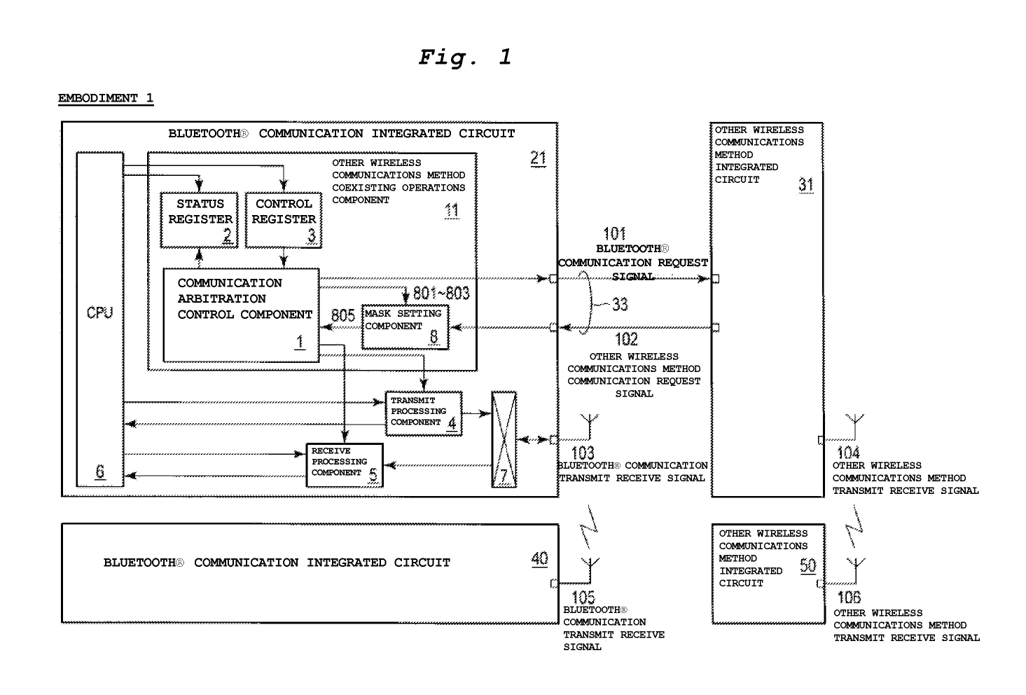

With reference to FIG. 1, an example of the overall configuration of the wireless communication system according to the first embodiment is described below. As shown in FIG. 1, the wireless communication system according to this example is deployed such that, the Bluetooth® communication integrated circuit 21 and the integrated circuit of other wireless communication methods 31 are coupled by means of a connection line in the form of a dedicated signal line 33, and these integrated circuits (21, 31) coexist on the same module. The dedicated signal line 33 is a line for the arbitration control of the communications of the two integrated circuits 21, 31, due to different communication methods. The Bluetooth® communication request signal 101 in the dedicated signal line 33 is a signal that is valid when Bluetooth® communication is requested. The other wireless communications method communication request signal 102 is a signal that is valid when other wireless communication is requested.

In this example, the Bluetooth® communication integrated circuit 21 uses the Bluetooth® standard to carry out wireless communication with other Bluetooth® communication integrated circuit 40, by means of the Bluetooth® communication transmit/receive signals 103.

In this example, the integrated circuit of other wireless communications method 31 uses a communication standard which conforms to other arbitrary wireless communication standards using overlapping frequency bands, and is different from the Bluetooth® standard, for example, WiFi communication, etc., to carry out wireless communication with another “other wireless communications method integrated circuit” 50, by means of the other wireless communication method transmit/receive signal 104.

The Bluetooth® communication integrated circuit 21 includes a transmit processing component 4, a receive processing component 5, a CPU 6, a communication control component 7, and an “other wireless communications method coexisting operations” component 11.

The Central Processing Unit (CPU) 6 controls the overall operation of this Bluetooth® communication integrated circuit 21.

Under the control of the CPU 6, the transmit processing component 4 processes the transmit signal of Bluetooth® communication to be transmitted towards the other Bluetooth® communication integrated circuit 40, and outputs the transmit signal to the communication control component 7.

For the receive processing component 5, the receive signal of the Bluetooth® communication to be received from the other wireless communications method integrated circuit 30 is input from the communication control component 7, and the receive processing component 5 processes the receive signal under the control of the CPU 6.

Under the control of the CPU 6, the communication control component 7, converts the Bluetooth® communication transmit receive signal 103, as the transmit signal from the transmit processing component 4 or the receive signal towards the receive processing component 5.

The “other wireless communications method coexisting operations” component 11 includes a communication arbitration control component 1, a status register 2, a control register 3, and a mask setting component 8.

The communication arbitration control component 1 controls the communication arbitration with the integrated circuit of the other wireless communications method 31. More specifically, depending on the status of the Bluetooth® communication request signal 101, the other wireless communications method communication request signal 102, and the effective communication request signal 805, etc., the communication arbitration control component 1 makes Bluetooth® communication and other wireless communication methods co-exist, by controlling the transmit processing component 4 and the receive processing component 5.

The status register 2 stores the status information, etc., from the communication arbitration control component 1. The CPU 6 reads this status information and decides the status of the communication arbitration control component 1.

The control register 3 stores the control mode signals, etc., from the CPU 6. The operation of the communication arbitration control component 1 is thereby controlled.

The mask setting component 8 generates a mask interval depending on the control signals 801-803 input from the communication arbitration control component 1. This mask interval is set to restrict the interval for accepting (e.g., acceptance window) the communication request signal of the other wireless communications method 102 from the integrated circuit of the other wireless communications method 30. Also, using this mask interval, the other wireless communications method effective communication request signal 805 is generated. The details are described below.

### 1-2. Mask Setting Component of First Embodiment

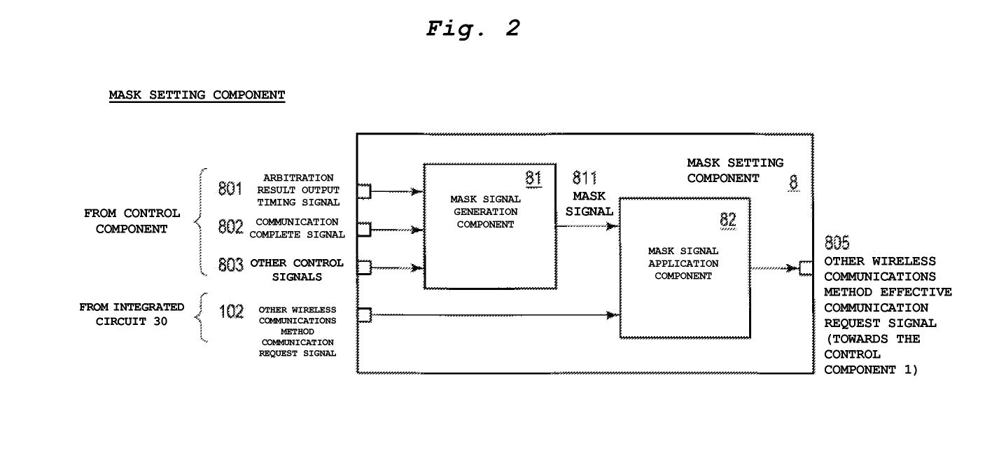

With reference to FIG. 2, a configuration example of the mask setting component 8 according to the first embodiment is described. As shown in FIG. 2, the mask setting component 8 includes a mask signal generation component 81 and a mask signal application component 82.

The mask signal generation component 81 is configured to use the arbitration result output timing signal 801, the communication complete signal 802, and the other control signals 803 input from the communication arbitration control component 1, to generate the mask signal 811.

The mask signal application component 82 is configured to use the mask signal 811 generated from the mask signal generation component 81, mask the other wireless communications method communication request signal 102 received from the other wireless communications method integrated circuit 31, generate the other wireless communications method effective communication request signal 805, and output this signal 805 to the communication arbitration control component 1.

### 2. Bluetooth® Multi-Slot Packet Communication of First Embodiment

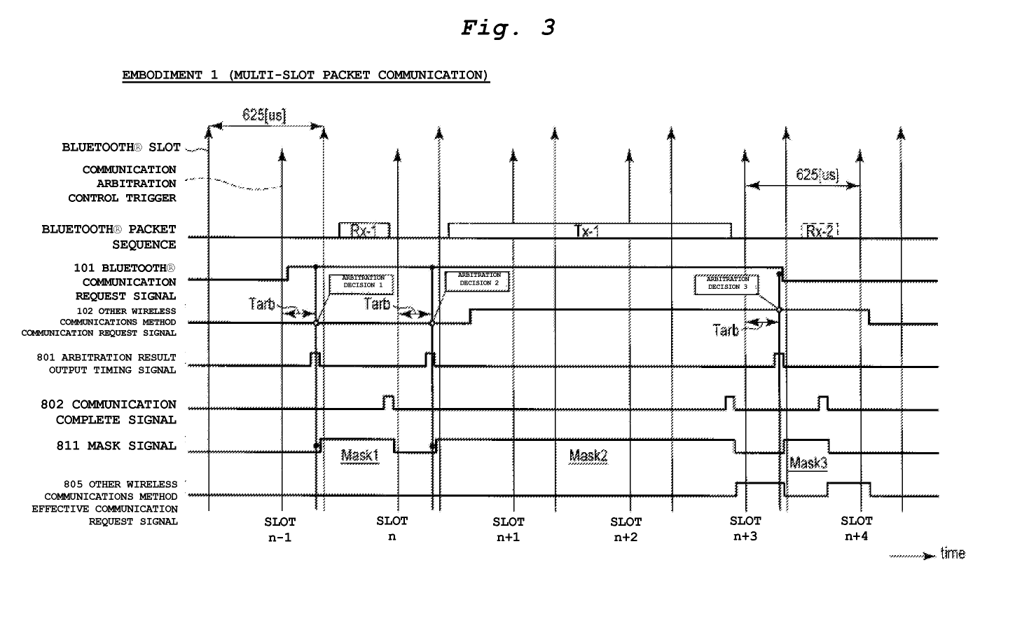

Next, with reference to FIG. 3, the timing chart of the communication of the wireless communication device and the wireless communication system according to the first embodiment are described below. Here, communication of Bluetooth® packets spanning multiple Bluetooth® slots (“Bluetooth® multi-slot packet”) is cited as an example.

As shown in FIG. 3, in Bluetooth® multi-slot packet communication, communication arbitration control is accomplished by the communication arbitration control component 1 with multiple of the Bluetooth® slots as one unit.

For example, first, in slot n−1, on the basis of the communication arbitration control trigger, if the Bluetooth® communication request signal 101 changes from invalid to valid (e.g., the request signal 101 changes from “L” to “H”), an arbitration decision 1 is made at the arbitration result output timing signal 801 that occurs at a specific timing (“Tarb” or “T arbitration”) in the slot n−1.

In this arbitration decision 1, since the other wireless communications method communication request signal 102 is invalid (e.g., “L” level), Bluetooth® communication has been permitted.

During this arbitration decision 1, since the arbitration result output timing signal 801 (e.g., pulse signal in FIG. 3) is input to the mask setting component 8, the mask signal generation component 81 changes the mask signal 811 from level “L to “H”, and generates the mask interval (e.g., mask interval 1). During the period of this mask interval 1, the mask signal 811 is valid and the other wireless communications method effective communication request signal 805 is invalid. Thus, even if the time to carry out an arbitration decision comes, and the other wireless communications method communication request signal 102 becomes valid during the period of this mask interval 1, the communication arbitration control component 1 will not accept the request signal 102.

Continuing, in slot n, if the reception of the receive signal Rx-1 by the receive processing component 5 is complete, the communication complete signal 802 occurs (e.g., pulse signal in FIG. 3) causing the mask signal generation component 81 to change the mask signal 811 to level “L”, and the mask interval 1 ends. Therefore, once the Bluetooth® communication integrated circuit 21 starts receiving Bluetooth® packet signals Rx-1 from the other Bluetooth® communication integrated circuit 40, such receiving is completed while the other wireless communications method effective communication request signal 805 continues in the invalid state.

Continuing, on the basis of the communication arbitration control trigger, if the Bluetooth® communication request signal 101 stays valid (e.g., stays “H”), an arbitration decision 2, similar to the arbitration decision 1, is made at the arbitration result output timing signal 801 that occurs at a specific time (Tarb) in the slot n.

As with the arbitration decision 1, even in the arbitration decision 2, because the other wireless communications method communication request signal 102 is Invalid (“L” level), Bluetooth® communication is permitted.

Similarly, even during the arbitration decision 2, because the arbitration result output timing signal 801 (e.g., pulse signal in FIG. 3) is input to the mask setting component 8, the mask signal generation component 81 changes the mask signal 811 from level “L to “H”, to generate mask interval 2 (mask 2). During the period of mask interval 2, mask signal 811 is valid and the other wireless communications method effective communication request signal 805 is invalid. Thus, even if the time to carry out an arbitration decision comes, and a new other wireless communications method communication request signal 102 becomes valid during the period of this mask interval 2, the communication arbitration control component 1 will not accept the request signal 102.

Continuing, in slot n+3, if the transmission of the Transmit signal Tx-1 by the transmit processing component 4 is complete, the communication complete signal 802 occurs (e.g., pulse signal in FIG. 3), the mask signal generation component 81 changes the mask signal 811 to level “L”, and the mask interval 2 ends. Therefore, once the Bluetooth® communication integrated circuit 21 starts transmitting Bluetooth® packet signals Tx-1 towards the other Bluetooth® communication integrated circuit 40, the transmission is completed while the other wireless communications method effective communication request signal 805 continues in the invalid state.

Continuing, if the communication arbitration control trigger rises and the Bluetooth® communication request signal 101 is valid, an arbitration decision 3, similar to the arbitration decision 1 and the arbitration decision 2, is made at the arbitration result output timing signal 801 that occurs at a specific timing (Tarb) in the slot n+3.

In the case of this arbitration decision 3, since the other wireless communications method communication request signal 102 is valid, the decision is made to prioritize the other wireless communications method over Bluetooth® communication such that the communication arbitration control component 1 changes the Bluetooth® communication request signal 101 from Valid (“H” level) to invalid (“L” level). In this case, reception of the Bluetooth® packet signal (Receive Rx-2) from the other Bluetooth® communication integrated circuit 40 is not guaranteed, and the communication of the other wireless communication method is prioritized. In the example of FIG. 3, since the reception of the packet signal (receive Rx-2) is not guaranteed, there is a possibility of failure of the reception of Rx-2.

In addition, in the case that the Bluetooth® communication integrated circuit 21 attempts to send a Bluetooth® packet signal, a control where the communication control arbitration component 1 can actively stop the transmission of the Bluetooth® packet, in accordance with the result of the arbitration decision 3, may also be implemented. If the transmission is stopped in this manner, when the communication of the other wireless communications method is prioritized, as in the arbitration decision 3, it is possible to prevent more interference.

However, even during this arbitration decision 3, similarly, since the arbitration result output timing signal 801 (e.g., pulse signal in FIG. 3) is input to the mask setting component 8, the mask signal generation component 81 changes the mask signal 811 from level “L to “H”, and generates the mask interval 3 (e.g., mask 3). As a result of detection of the reception failure of Rx-2, the communication complete signal 802 is generated, and once again mask signal 811 returns to level “L”. As with mask intervals 1 and 2,during the period of mask interval 3, the mask signal 811 is valid and the other wireless communications method effective communication request signal 805 is invalid. Thus, even if the time to carry out an arbitration decision comes, and a new other wireless communications method communication request signal 102 becomes valid during the period of this mask interval 3, the communication arbitration control component 1 will not accept the request signal 102.

Thereafter, substantially the same operations are repeated.

### 3. Effects of First Embodiment

According to the wireless communication device and wireless communication system of the first embodiment, at least the two effects can be attained.

In a first effect, as a result of communication arbitration, when communication is permitted with other wireless communication devices, it is possible to protect the communication of the entire packet. As described above, the first wireless communication device 21, according to this example, conforms to the Bluetooth® standard. Furthermore, the first wireless communication device 21, is deployed so as to co-exist on the same module with a second wireless communication device 31 conforming to another arbitrary wireless communication standard using overlapping frequency bands, and is deployed in a wireless communication system where it is possible to arbitrate and control the mutual communication by means of a dedicated signal line 33. When Bluetooth® communication is permitted for the first wireless communication device 21, the first wireless communication device 21 carries out wireless communication with a third wireless communication device 40 that conforms to the Bluetooth® standard.

Furthermore, the first wireless communication device 21 includes a mask setting component 8, which generates a mask interval not allowing the acceptance of communication requests from the second wireless communication device 31 that conforms to an arbitrary wireless standard.

Hence, for example, as explained above with reference to FIG. 3, if the control trigger rises and the Bluetooth® communication request signal 101 is valid, an arbitration decision is made at the arbitration result output timing signal 801 that occurs at a specific timing (Tarb). For example, during the arbitration decision 2, since the arbitration result output timing signal 801 (e.g., pulse signal in FIG. 3) is input to the mask setting component 8, the mask signal generation component 81 changes the mask signal 811 from level “L to “H”, and generates the mask interval 2 (e.g., mask 2). During the period of this mask interval 2, the mask signal 811 is valid and the other wireless communications method effective communication request signal 805 is invalid. Thus, even if the time to carry out an arbitration decision comes, and the other wireless communications method communication request signal 102 becomes valid during the period of this mask interval 2, the communication arbitration control component 1 will not accept the request signal 102. Therefore, once the Bluetooth® communication integrated circuit 21 starts transmitting Bluetooth® packet signals Tx-1 towards the other Bluetooth® communication integrated circuit 40, the transmission is completed while the other wireless communications method effective communication request signal 805 continues in the invalid state.

In this manner, in this example, as a result of communication arbitration by the communication arbitration control component 1, when communication with the other Bluetooth® communication device 40 is permitted, by generating a mask interval and using the other wireless communications method effective communication request signal 805 that reflects the effects of that mask, it is possible to process the transmit receive signals. Therefore, as an advantage, the communication of the entire packet can be protected.

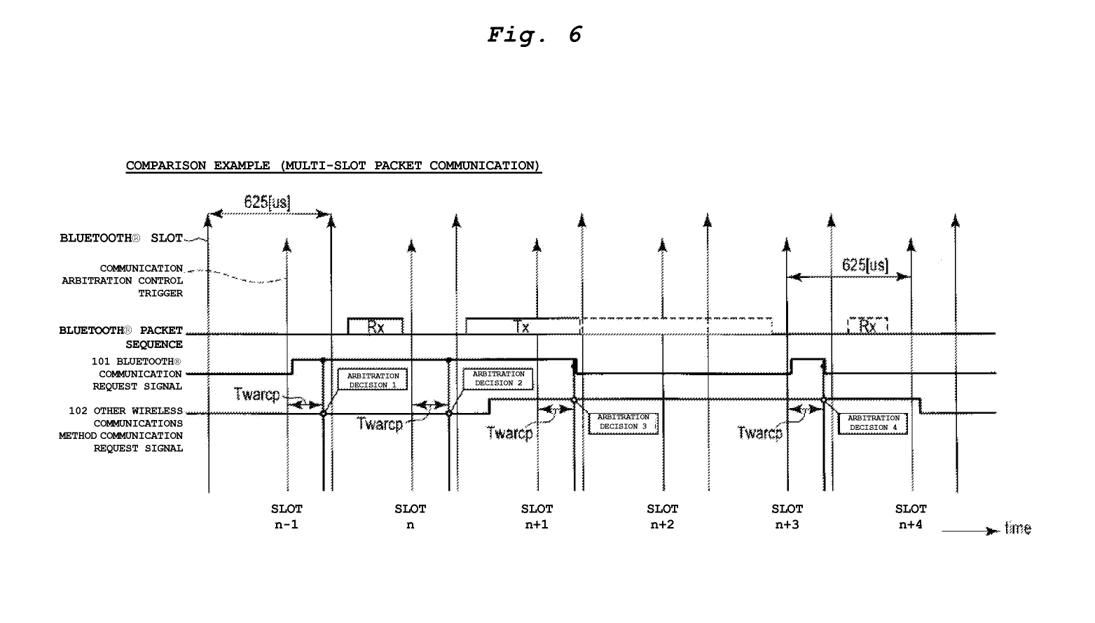

On the other hand, for example, as in the comparison example described below in FIG. 6, multi-slot packet has the disadvantage of, for the slots n+2 and n+3 of the transmission packets of the portions indicated by the dashed line, obstructed communication there between.

In a second effect, communication arbitration is advantageous for implementation. Here, in Bluetooth® communication, it is necessary to manage communication in a fixed length of time, and depending on the application, transmit and receive the packets at certain specific intervals. For example, voice and audio apply to such an example. In this example, when multiple wireless communication methods coexist, in order to maintain the quality of applications such as voice and audio, control is often implemented to conform with fixed-length time management such as Bluetooth®.

In this example, for such circumstances, there is an advantage in terms of implementation that it is possible to protect the communication of the entire packet pertaining to transmission and reception as well as maintain the quality of the application.

Furthermore, as in this first embodiment, when communication of Bluetooth® packets spanning multiple Bluetooth® slots (Bluetooth® multi-slot packet) is to be carried out, the wireless communication device and system are even more efficient.

### Second Embodiment

Next, the wireless communication device and wireless communication system, according to a second embodiment, are described below. The second embodiment is related to an example of the Bluetooth® low energy standard. Bluetooth® low energy standard (“LE standard”) is a new standard of the Bluetooth® standard wherein communication is done in Bluetooth® packet bursts such that Bluetooth® packets are bunched together at fixed time intervals. In this description, detailed description of portions that duplicate the above-described first embodiment is omitted.

### 4. Configuration of Second Embodiment

Because a configuration example of the second embodiment is substantially similar to those shown in FIG. 1 and FIG. 2 of the first embodiment, a brief description of the configuration example is provided below, but a detailed description of the configuration example is omitted.

Even in the case of the LE standard of this example, when communication arbitration control is carried out for each Bluetooth® slot, it is possible that the Bluetooth® packet burst for which communication start is allowed at first, can be obstructed in between. In keeping with the aim of the LE standard to accomplish low power consumption by minimizing the active time window by completing transmission of the Bluetooth® packet burst in that time window and causing a sleep state at other times, obstruction necessitates a resend of the Bluetooth® packet burst, which is an inconsistent operation.

Therefore, even in the second embodiment, a mask interval is generated by the mask setting component 8. Hence, during the communication interval of the Bluetooth® packet burst of LE standard, once communication has been allowed, the suspend as mentioned above does not occur in the Bluetooth® device 21 because communication arbitration control from the device 31 of another arbitrary wireless standard is not accepted.

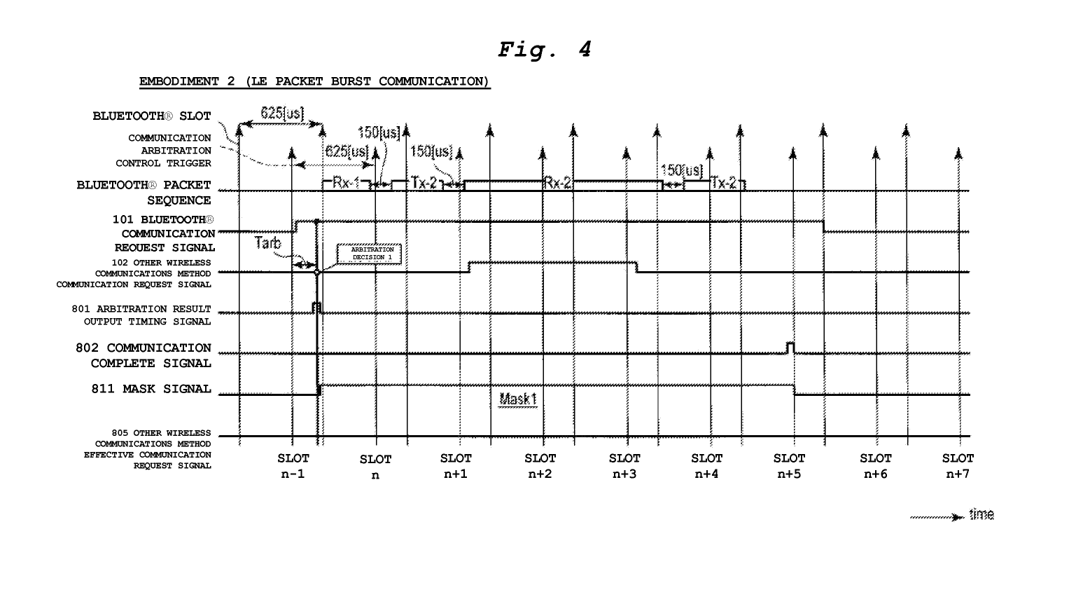

Next, the timing chart of the communication of the wireless communication device and the wireless communication system, according to the second embodiment, is described in accordance with FIG. 4. Here, the communication of a group of consecutive Bluetooth® packets conforming with the LE standard (“Bluetooth® LE packet burst”) is cited as an example.

As shown in the figure, first, during slot n−1, on the basis of the communication arbitration control trigger, if the Bluetooth® communication request signal 101 changes from invalid to valid (e.g., changes from “L” to “H”), an arbitration decision 1 is made at the arbitration result output timing signal 801 that occurs at a specific timing (Tarb) in the slot n−1.

In this arbitration decision 1, since the other wireless communications method communication request signal 102 is invalid (“L” level), the decision is made to permit Bluetooth® communication.

During this arbitration decision 1, since the arbitration result output timing signal 801 (e.g., pulse signal in FIG. 3) is input to the mask setting component 8, the mask signal generation component 81 changes the mask signal 811 from level “L to “H” and generates the mask interval 1 (e.g., mask 1). During the period of this mask interval 1, the mask signal 811 is valid and the other wireless communications method effective communication request signal 805 is invalid. Thus, even if the time to carry out an arbitration decision comes, and the other wireless communications method communication request signal 102 becomes valid during the period of this mask interval 1, the communication arbitration control component 1 will not accept the request signal 102.

Hence, with the other wireless communications method effective communication request signal 805 set in the invalid state due to this mask interval 1, the LE packet signal Rx-1 is received from the other Bluetooth® communication integrated circuit 40.

Continuing, with the other wireless communications method effective communication request signal 805 set in the invalid state due to mask interval 1, LE packet signals Tx-1 continue to be sent from Rx-1.

Continuing, during slot n+1, even if the other wireless communications method communication request signal 102 changes from Level “L” to Level “H”, because the other wireless communications method effective communication request signal 805 is set as invalid by mask interval 1, LE packet signals Rx-2 are received following Tx-1.

Continuing, similarly, with the other wireless communications method effective communication request signal 805 set in the invalid state due to mask interval 1, LE packet signals Tx-2 are sent following Rx-2.

Continuing, during slot n+5, if the transmission of the transmit signal Tx-2 by the transmit processing component 4 is complete, the communication complete signal 802 occurs (e.g., pulse signal in FIG. 3), the mask signal generation component 81 changes the mask signal 811 to level “L”, and the mask interval 1 ends.

Thereafter, substantially the same operations are repeated. Other configurations, operations, etc., of the second embodiment are substantially similar to those of the first embodiment described above.

### 5. Effects of Second Embodiment

As described above, with the wireless communication device and wireless communication system according to the second embodiment, effects similar to the two effects described above in the first embodiment can be achieved. Furthermore, at least the effects shown below can be achieved.

As described above, even with use of Bluetooth® LE packet burst communication as in the second embodiment, it is possible to protect the communication of the entire Bluetooth® LE packet burst. Depending on the need, it is possible to adopt this example.

Furthermore, in Bluetooth® LE packet burst communication, as shown in FIG. 4, when the result of the arbitration decision 1 permits Bluetooth® communication, with the other wireless communications method effective communication request signal 805 set in the invalid state due to mask interval 1, it is possible to communicate LE packet signals (Rx-1, Tx-1, Rx-2, Tx-2) continuously.

In this manner, since it is possible to carry out communication continuously without being forced to re-transmit Bluetooth® packet bursts, it becomes possible to minimize the Active time window, and complete the communication of the Bluetooth® LE packet bursts in the time window of mask interval 1 while otherwise causing a sleep state.

Consequently, it is highly advantageous from the perspective that, by adopting this second embodiment in an environment where the second embodiment co-exists with other wireless communication methods, it is possible to maximize the characteristics of Bluetooth® LE packet burst communication and reduce power consumption.

### 6. Comparison Example of First and Second Embodiments

Next, a comparison example is described in order to compare the wireless communication device and wireless communication systems according to the above-described first and second embodiments.

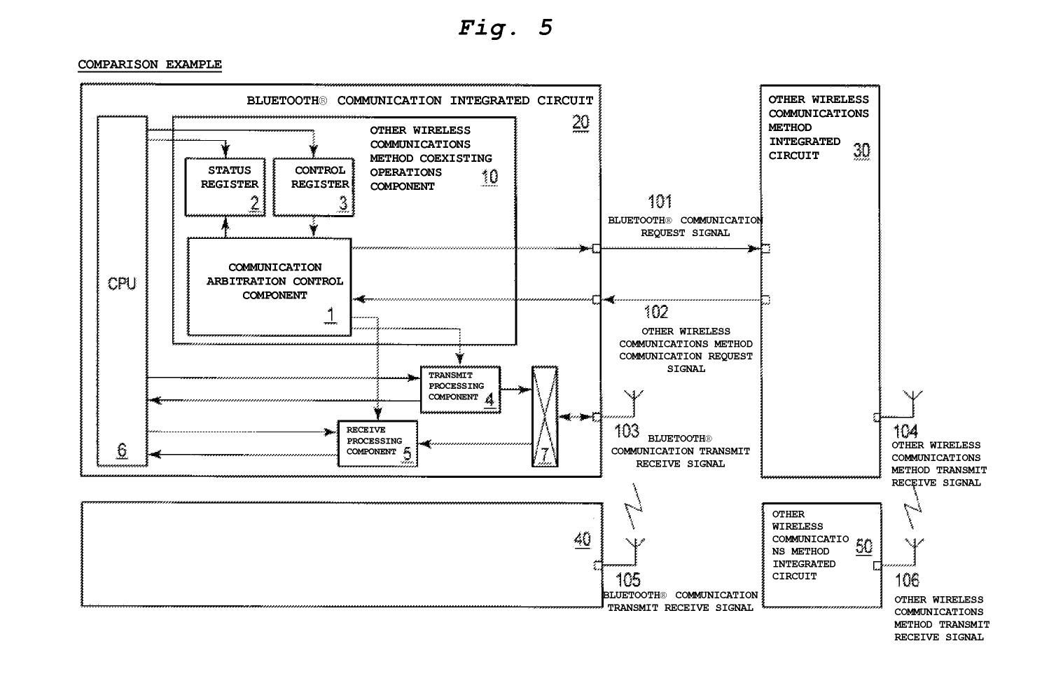

FIG. 5 shows a wireless communication system according to the comparison example, which deploys a Bluetooth® device 20 having a connection line 33 of a dedicated signal line required for the arbitration control of communication with the wireless communication device 30 of another wireless communications method.

As shown in the FIG. 5, in order to implement communication arbitration control with the other wireless communications method integrated circuit 30, the Bluetooth® communication integrated circuit 20 has an “other wireless communications method coexisting operations” component 10 built-in. The Bluetooth® communications request signal 101 is a signal that is valid when Bluetooth® communication is requested, and the other wireless communications method communication request signal 102 is also a similar signal. The communication arbitration control component 1 allows Bluetooth® communication and other wireless communication methods to co-exist by controlling the transmit processing component 4 and the receive processing component 5, depending on the state of these signals.

Nevertheless, the Bluetooth® communication integrated circuit 20, according to the comparison example, differs from the first and second embodiments in that the Bluetooth® communication integrated circuit 20 does not possess the mask setting component 8.

### 7. Bluetooth® Multi-Slot Packet Communication

FIG. 6 is a timing chart diagram showing a multi-slot packet communication of a wireless communication integrated circuit according to a reference example. Here, similarly, Bluetooth® multi-slot packet communication is cited as an example.

For example, in Slot n, at the time of the communication arbitration control trigger, if the Bluetooth® communication request signal 101 is valid, at a specific timing (Tarb) from Slot n, arbitration decision 2 is made. As a result of this arbitration decision 2, if Bluetooth® communication is permitted, the LE packet signal Tx is transmitted.

Continuing, although at a specific timing (Tarb) from slot n+1, arbitration decision 3 is made, at this time, since the other wireless communications method communication request signal 102 is valid, the result of this arbitration decision 3 is a decision in which the other wireless communications method is permitted. Due to this result, the Bluetooth® communication request signal 101 changes from level “H” to the level “L” indicating invalid, and as shown in the figure by the dotted line, the transmission of the incomplete LE packet signal Tx gets suspended in between.

In this manner, since the mask setting component 8 according to the first and second embodiments is not provided in the reference example, it is not possible to set the mask interval. Consequently, the reference example has the disadvantage that, during the communication interval of the Bluetooth® multi-slot packet, once communication has been allowed, if the Bluetooth® device 20 receives a new communication arbitration control from the device 30 of another arbitrary wireless standard, communication interruption occurs.

As described above, in Bluetooth®, it is necessary to manage communication in time units of fixed length and, depending on the application, transmit and receive the packets at certain specific intervals. For example, voice and audio apply to such an example. When multiple wireless communication methods coexist, in order to prioritize and maintain the quality of applications such as voice and audio over other applications, although control is often done so as to conform to fixed length time management such as Bluetooth®, in the comparison example such as one which carries out simple arbitration control in fixed length time units, there may be cases where it is difficult to maintain quality.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A first wireless communication device configured to carry out wireless communication according to a first standard, and to be connected to a second wireless communication device, which is configured to carry out wireless communication according to a second standard that is different from the first standard, the first wireless communication device comprising:
an arbitration component configured to arbitrate wireless communication usage between the first and second wireless communication devices; and
a mask setting component configured to generate a mask interval during which the wireless communication usage is not permitted to be switched between the first and second wireless communication devices.

2. The first wireless communication device according to claim 1, wherein the mask setting component generates the mask interval when the arbitration component grants permission to the first communication device to carry out the wireless communication.

3. The first wireless communication device according to claim 2, wherein the first standard is a Bluetooth® communication standard and the mask interval is defined in units of Bluetooth® time slots.

4. The first wireless communication device according to claim 3, wherein a Bluetooth® packet is wirelessly communicated between the first wireless communication device and a third wireless communication device and the mask interval is defined according to a size of the Bluetooth® packet.

5. The first wireless communication device according to claim 1, wherein the first wireless communication device and the second wireless communication device are installed within a common housing.

6. The first wireless communication device according to claim 5, wherein the first wireless communication device and the second wireless communication device are connected by a bi-directional signal line.

7. The first wireless communication device according to claim 6, wherein the arbitration component is configured to issue a request signal on the bi-directional signal line when requesting usage of the wireless communication.

8. The first wireless communication device according to claim 6, wherein the arbitration component is configured to detect a request signal on the bi-directional signal line issued by the second wireless communication device.

9. A wireless communication device comprising:
a first wireless communication device configured to carry out wireless communication according to a first standard;
a second wireless communication device configured to carry out wireless communication according to a second standard different from the first standard; and
a signal line connecting the first and second wireless communication devices by which wireless communication arbitration control between the first and second wireless communication devices is carried out,
wherein the first wireless communication device includes a mask setting component that is configured to generate a mask interval during which the first wireless communication device does not accept a wireless communication request from the second wireless communication device.

10. The wireless communication device according to claim 9, wherein the mask setting component generates the mask interval when the first communication device has been granted permission to carry out the wireless communication.

11. The wireless communication device according to claim 10, wherein the first standard is a Bluetooth® communication standard and the mask interval is defined in units of Bluetooth® time slots.

12. The wireless communication device according to claim 11, wherein a Bluetooth® packet is wirelessly communicated between the first wireless communication device and a third wireless communication device and the mask interval is defined according to a size of the Bluetooth® packet.

13. The wireless communication device according to claim 9, wherein the signal line is bi-directional signal line, and a request signal is issued on the bi-directional signal line when requesting usage of the wireless communication.

14. A method of arbitrating wireless communication usage between a first wireless communication device configured to carry out wireless communication according to a first standard and a second wireless communication device configured to carry out wireless communication according to a second standard that is different from the first standard, said method comprising:
granting permission to the first wireless communication device to communicate with a third wireless communication device; and
generating a mask interval during which the wireless communication usage is not permitted to be switched from the first wireless communication device to the second wireless communication device.

15. The method according to claim 14, wherein the first standard is a Bluetooth® communication standard and the mask interval is defined in units of Bluetooth® time slots.

16. The method according to claim 15, wherein a Bluetooth® packet is wirelessly communicated between the first wireless communication device and the third wireless communication device and the mask interval is defined according to a size of the Bluetooth® packet.

17. The method according to claim 14, wherein the first wireless communication device and the second wireless communication device are installed within a common housing.

18. The method according to claim 17, wherein the first wireless communication device and the second wireless communication device are connected by a bi-directional signal line.

19. The method according to claim 18, further comprising:
prior to said granting, issuing a request signal on the bi-directional signal line by the first wireless communication device to request usage of the wireless communication.

20. The method according to claim 18, further comprising:
detecting a request signal on the bi-directional signal line issued by the second wireless communication device; and
conditionally accepting the request signal.
